(19) United States
(12) Patent Application Publication
(10) Pub. No.: US 2024/0410595 A1
(43) Pub. Date: Dec. 12, 2024

(54) Multiduty Cooking Appliance

(71) Applicant: Ningbo Bai-Jia Electric Appliance Co., Ltd., Cixi (CN)

(72) Inventor: Junfa Ye, Cixi (CN)

(21) Appl. No.: 18/522,060

(22) Filed: Nov. 28, 2023

(30) Foreign Application Priority Data
Jun. 12, 2023 (CN) 202321492200.4

(51) Int. Cl. F24C 15/32; A47J 27/00; F24C 7/08; F24C 15/00

(52) U.S. Cl. CPC F24C 15/325; A47J 27/004; F24C 7/082; F24C 15/006

(57) ABSTRACT

A multiduty cooking appliance comprises a heating base, a cooker body, a heating head, a first electric heating device, and a second electric heating device, the cooker body encloses a cooking chamber. The first electric heating device and the second electric heating device are independent of each other. The bottom of the cooker body is placed on the heating base, the cooking chamber is disposed on top of the first electric heating device and the first electric heating device is capable of heating the cooking chamber. The heating head is placed on the top of the cooker body and covers the cooking chamber, and the second electric heating device inside the heating head is capable of heating the cooking chamber. The heating base, the cooker body and the heating head can be combined to form multiple usage modes. The heating base can be used independently as an induction cooker or an electric cooker, so the cooking appliance can be used in a wide range.

### TECHNICAL FIELD OF THE INVENTION

The present invention relates to kitchen cooking appliance and in particular to a multiduty cooking appliance.

### BACKGROUND OF THE INVENTION

There are a wide variety of kitchen cooking appliances, such as pressure cookers, induction cookers, steamers, electric cookers and air fryers. The existing kitchen cooking appliances have their own characteristics and can only be used alone.

At present, multiduty air fryers have also been developed. For example, a Chinese Invention Patent CN114287810A, entitled MULTIPURPOSE AIR FRYER, disclosed such an air fryer which comprises a fryer body in which a first heating chamber, a heat radiating chamber and a second heating chamber are arranged, wherein the first heating chamber, the heat radiating chamber and the second heating chamber are sequentially distributed in the height direction of the fryer body; a first heating component and a first impeller are arranged at the bottom end of the first heating chamber, and the bottom wall of the first heating chamber is formed as a heating portion; the first impeller is used to guide heat to the heating portion during rotation; a second heating component and a second impeller are arranged in the second heating chamber, and the second heating component is used to heat air in the second heating chamber; the second impeller is rotatably mounted in the second heating chamber; an air inlet hole is formed on the sidewall of the heat radiating chamber; a driving member and a heat radiating fan are arranged in the heat radiating chamber; and, the driving member is used to drive the heat radiating fan, the first impeller and the second impeller to rotate. The air fryer can realize multiple purposes, such as baking, steaming or frying.

Although the air fryer has multiple functions, the first heating chamber, the heat radiating chamber and the second heating chamber are integrated and cannot be used independently, so that the range of applicability of the product is limited, and the whole product is large, heavy and inconvenient to store and carry. Moreover, the heating position in the upper portion of the product is high, that is, the cooking position is high, so the usage is inconvenient for users.

Therefore, the technical problem to be solved by those skilled in the art is to design a flip-open air fryer with simpler and more reasonable structure and steaming function.

### SUMMARY OF THE INVENTION

It is an object of the present invention to provide a multiduty cooking appliance, which is simpler and more reasonable in structure and whose main components can be detached and combined in different usage modes.

For achieving the above object, the multiduty cooking appliance comprises a heating base, a cooker body having a top and a bottom, a heating head, a first electric heating device disposed inside the heating base, and a second electric heating device disposed inside the heating head; wherein the cooker body encloses a cooking chamber and has an opening on the top; the first electric heating device and the second electric heating device are independent of each other; when the bottom of the cooker body is placed on the heating base, the cooking chamber is disposed on top of the first electric heating device and the first electric heating device is capable of heating the cooking chamber; when the heating head is placed on the top of the cooker body and covers the cooking chamber, and the second electric heating device inside the heating head is capable of heating the cooking chamber.

Preferably, a first power interface for receiving a power wire to supply power to the first electric heating device, and the heating head has a second power interface for receiving a power wire to supply power to the second electric heating device. The first power interface and the second power interface can be matched with the same power wire. When the heating base needs to be used, it is only necessary to plug the power wire into the first power interface; and, when the heating head needs to be used, it is only necessary to plug the power wire into the second power interface. Therefore, only one power wire is needed in the cooker. In addition, when packaging, the power wire can be detached from the heating base or the beating head, so that it is convenient for storage. Of course, it is also possible that the non-detachable power wire is directly arranged on the heating base and the heating head. In the existing air fryers, the power wire is arranged on the bottom of the fryer body, but not on the top of the heating head.

Preferably, the first electric heating device is an electric heating tube type heating structure, an induction cooker type heating structure or a microcrystalline heating structure, and a temperature adjustment control panel or a button is arranged at a front side of the heating base. Of course, the first electric heating device may also be other existing electric heating structures.

Preferably, the second electric heating device is an air fryer type heating mechanism, and comprises a motor having a output shaft, a cooling fan, a heat circulating fan and a heating tube, both the cooling fan and the heat circulating fan are connected to the output shaft of the motor, a control knob or a control panel is arranged on the heating head. Thus, the heating head is used with the cooker body to realize an air fryer.

Preferably, positioning mechanisms are respectively arranged between a top of the heating base and the bottom of the cooker body, and between a bottom of the heating head and the top of the cooker body. The positioning mechanisms between the heating base and the cooker body can make the cooker body stably rest on the heating base, so that it is difficult to separate the cooker body from the heating base and a stable electric steamer is realized as a whole. The positioning mechanisms between the heating head and the cooker body can make the heating head stably rest on the top of the cooker body, so that it is difficult to separate the heating head from the cooker body and a stable air fryer is realized as a whole.

As a specific implementation of the positioning mechanisms between the heating base and the cooker body, preferably, an annular first positioning step is formed on the top of the heating base, a first positioning recess for receiving the positioning step is formed on the bottom of the cooker body, when the cooker body is placed on the heating base the first positioning step latches inside the first positioning recess. Of course, it is also possible that the first positioning step is provided on the bottom of the cooker body and the first positioning recess is provided on the top of the heating base.

Preferably, the first electric heating device having a heating surface is positioned inside the heating base and is capable of floating up and down, and the first electric heating device is supported by springs to extend the heating surface of the first electric heating device beyond a top surface of the first positioning step. The first electric heating device is supported by springs and is kept in a trend of beyond the top surface of the first positioning step, so that the heating device can be fully close to the cooker body, and the heating effect is better.

As a specific implementation of the positioning mechanisms between the heating head and the cooker body, preferably, an annular second positioning flange is formed on the top of the cooker body, a second positioning recess receiving the second positioning flange is formed on the bottom of the heating head, when the heating head is placed on the cooker body the second positioning flange latches inside the second positioning recess. Of course, it is also possible that the second positioning step is provided on the bottom of the heading head and the second positioning recess is provided on the top of the cooker body.

Preferably, a seal ring is arranged on the bottom surface of the heating head, so as to form a seal between the heating head and the cooker body when the heating head is placed on the top of the cooker body. When the heating head is used with the cooker body as an air fryer, the seal ring results in a good sealing between the heating head and the cooker body, thereby improving the heating effect of the air fryer.

Preferably, the cooker body comprises a housing and a cooking container with an inner chamber; the housing has a shell with an inner wall and a liner with a peripheral wall which flares outwardly towards the bottom of the liner, the liner has a circular through hole running through the liner, and the cooking container is removably placed inside the through hole; a heat insulating space is defined between the inner wall of the shell and the peripheral wall of the liner; the cooking container has an outwardly flaring edge on the top of the cooking container which rests on the top of the liner, and the inner chamber of the cooking container is defined as the cooking chamber. The arrangement of the heat insulating space prevents the outer surface of the cooker body from scalding hands during use. The body is removably placed in the placement hole, and the top of the body has a turn-up edge resting on the top surface of the liner, so that it is convenient to place the body in the pedestal or take the body out of the base. The placement hole runs through the liner, so that the first heating device can directly come into contact with the body, and the efficiency of heating the body is higher.

Compared with the prior art, in the present invention, the heating base, the cooker body and the heating head are independent of each other and also cooperate with each other, and the first electric heating device and the second electric heating device are independent of each other, therefore, the three components can be combined to form multiple usage modes. In detail, the combination of the heating base and the cooker body in conjunction with a conventional lid can be used as a steamer, and the combination of the cooker body and the heating head can be used as an air fryer. Moreover, the overall height of such combination is not large, so it is convenient for placement. In addition, the heating base can be independently used as an induction cooker or an electric cooker, and the heating base can be used with a conventional pot or teapot, the cooking appliance can expand a variety of usage modes, so that the cooking appliance has a wide range of application.

### BRIEF DESCRIPTION OF THE DRAWINGS

FIG. 1 is a perspective view of a cooking appliance seen from the front side according to an embodiment of the present invention;

FIG. 2 is a perspective view of the cooking appliance seen from the back side according to the embodiment of the present invention;

FIG. 3 is a sectional view of the cooking appliance according to the embodiment of the present invention;

FIG. 4 is an enlarged view of part-A in FIG. 3;

FIG. 5 is an enlarged view of part-B in FIG. 3;

FIG. 6 is an exploded view of the cooking appliance according to the embodiment of the present invention;

FIG. 7 is a perspective view of the cooking appliance used in an air fryer mode according to the embodiment of the present invention;

FIG. 8 is a perspective view of the cooking appliance used in a steamer mode according to the embodiment of the present invention;

FIG. 9 is an exploded view of the cooker body according to the embodiment of the present invention; and

FIG. 10 is a perspective view of the heating head according to the embodiment of the present invention.

### DETAILED DESCRIPTION OF THE INVENTION

The present invention will be further described below in detail by an embodiment with reference to the accompanying drawings.

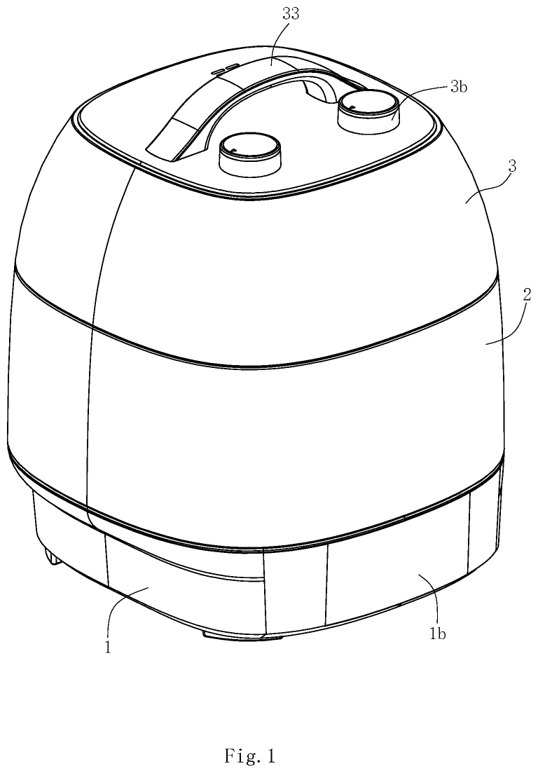

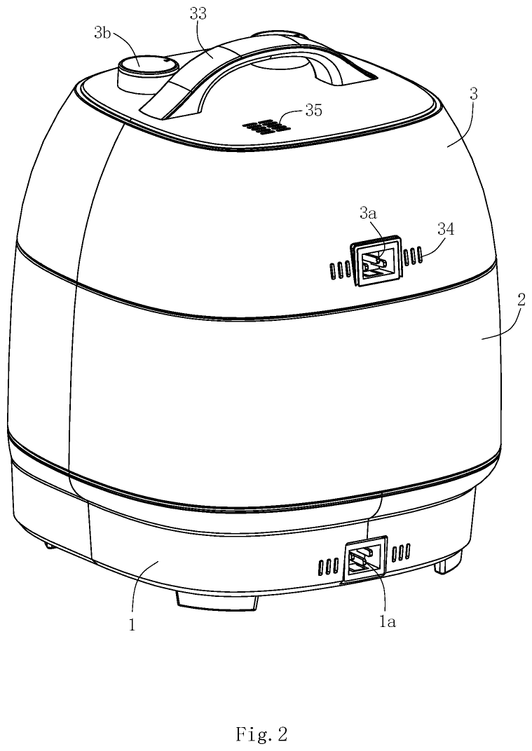

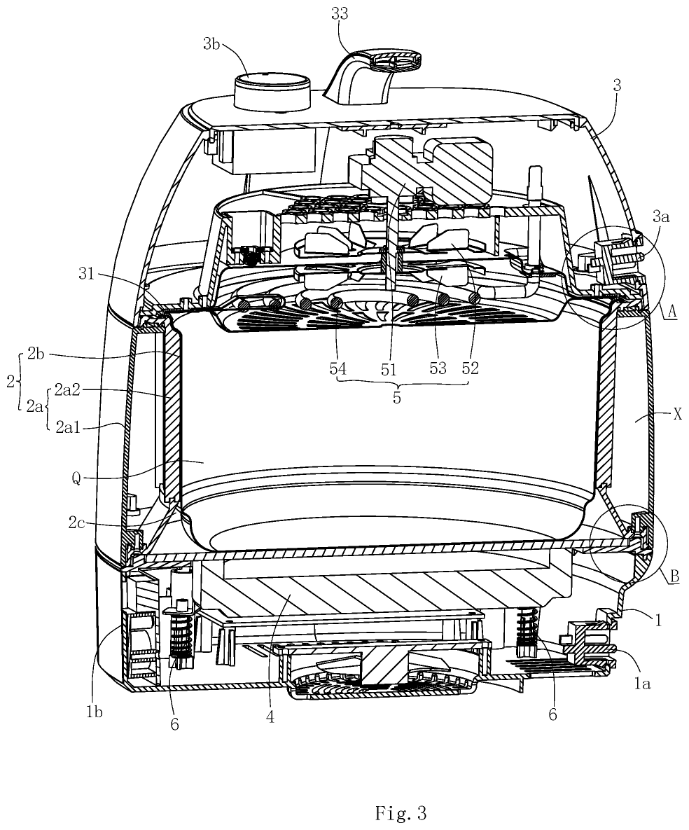

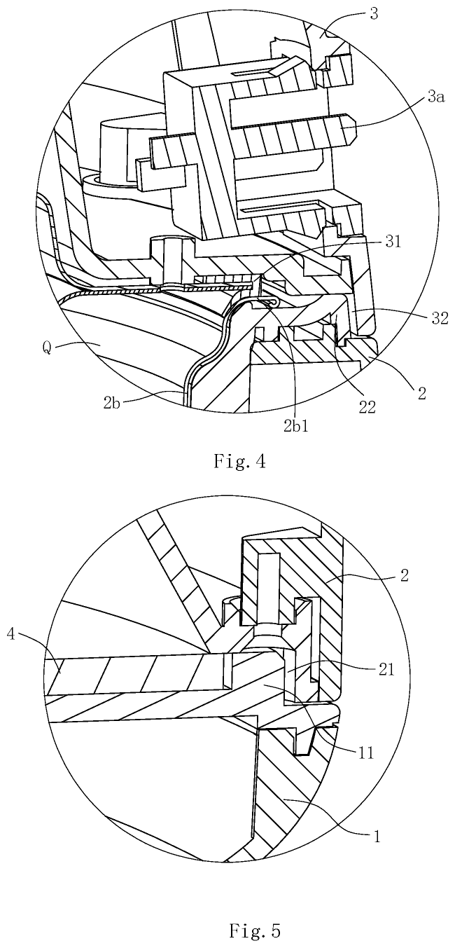

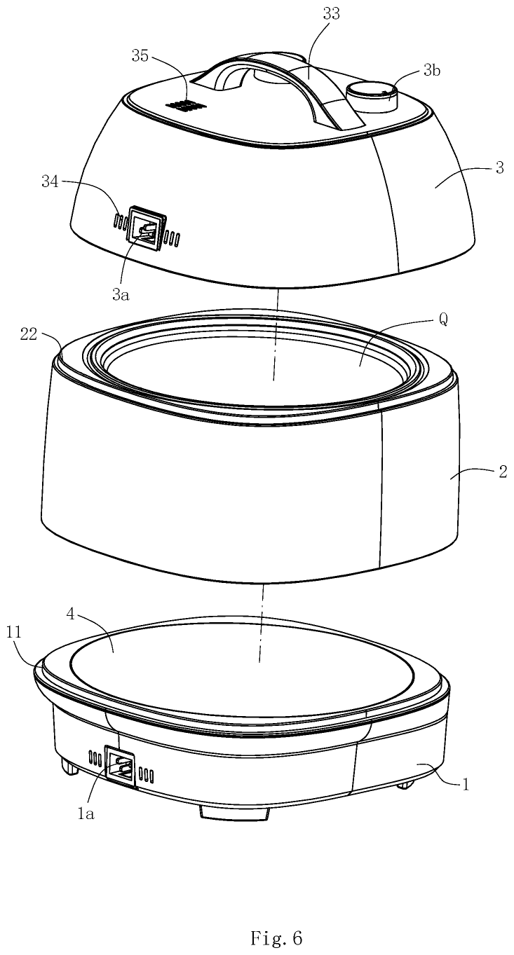

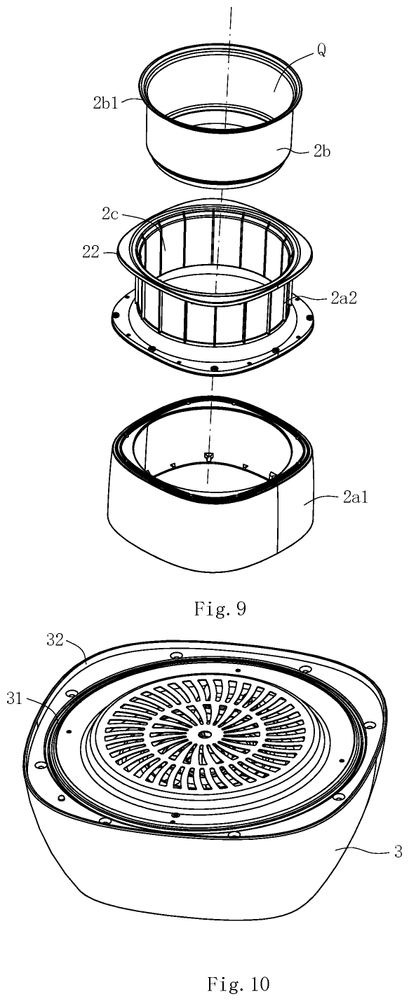

FIGS. 1-10 show a preferred embodiment of the present invention.

The multiduty cooking appliance comprises a heating base 1, a cooker body 2 having a top and a bottom, a heating head 3, a first electric heating device 4 disposed inside the heating base 1, and a second electric heating device 5 disposed inside the heating head 3, the cooker body 2 encloses a cooking chamber Q and has an opening on the top. The first electric heating device 4 and the second electric heating device 5 are independent of each other. The bottom of the cooker body 2 is placed on the heating base 1, the cooking chamber Q is disposed on top of the first electric heating device 4 and the first electric heating device 4 is capable of heating the cooking chamber Q. The heating head 3 is placed on the top of the cooker body 2 and covers the cooking chamber Q, and the second electric heating device 5 inside the heating head 3 is capable of heating the cooking chamber Q.

The heating base 1 has a first power interface 1a for receiving a power wire to supply power to the first electric heating device 4, and the heating head 3 has a second power interface 3a for receiving a power wire to supply power to the second electric heating device 5.

The first electric heating device 4 is an electric heating tube type heating structure, an induction cooker type heating structure or a microcrystalline heating structure, and a temperature adjustment control panel 1b or a button is arranged at a front side of the heating base 1.

In this embodiment, the second electric heating device 5 is an air fryer type heating mechanism, and comprises a motor 51 having a output shaft, a cooling fan 52, a heat circulating fan 53 and a heating tube 54, both the cooling fan 52 and the heat circulating fan 53 are connected to the output shaft of the motor 51, a control knob 3b or a control panel is arranged on the heating head 3. An air inlet hole 34 and an air outlet hole 35 are further formed on the heating head 3 for use as an air fryer. The air inlet hole 34 and the air outlet hole 35 are conventional designs of the heating head for use as the air fryer.

The positioning mechanisms are respectively arranged between a top of the heating base 1 and the bottom of the cooker body 2, and between a bottom of the heating head 3 and the top of the cooker body 2.

An annular first positioning step 11 is formed on the top of the heating base 1, a first positioning recess 21 for receiving the positioning step 11 is formed on the bottom of the cooker body 2, when the cooker body 2 is placed on the heating base 1 the first positioning step 11 latches inside the first positioning recess 21. In this embodiment, the first electric heating device 4 having a heating surface is positioned inside the heating base 1 and is capable of floating up and down, and the first electric heating device 4 is supported by a-springs 6 to extend the heating surface of the first electric heating device 4 beyond a top surface of the first positioning step 11.

An annular second positioning flange 22 is formed on the top of the cooker body 2, a second positioning recess 32 receiving the second positioning flange 22 is formed on the bottom of the heating head 3, when the heating head 3 is placed on the cooker body 2 the second positioning flange 22 latches inside the second positioning recess 32.

A seal ring 31 is arranged on the bottom surface of the heating head 3, so as to form a seal between the heating head 3 and the cooker body 2 when the heating head 3 is placed on the top of the cooker body 2. A handle 33 for the convenience of carrying is provided on the top of the heating head 3.

In this embodiment, the cooker body 2 comprises a housing 2a and a cooking container 2b with an inner chamber. The housing 2a has a shell 2al with an inner wall and a liner 2a2 with a peripheral wall which flares outwardly towards the bottom of the liner 2a2, the liner 2a2 has a circular through hole 2c running through the liner 2a2, and the cooking container 2b is removably placed inside the through hole 2c. A heat insulating space X is defined between the inner wall of the shell 2al and the peripheral wall of the liner 2a2. The cooking container 2b has an outwardly flaring edge 2b1 on the top of the cooking container 2b which rests on the top of the liner 2a2, and the inner chamber of the cooking container 2b is defined as the cooking chamber Q.

The heating base 1, the cooker body 2 and the heating head 3 are independent of each other and also cooperate with each other, and the first electric heating device 4 and the second electric heating device 5 are independent of each other. Therefore, these three components can be combined to form multiple usage modes as below.

Steamer mode: as shown in FIG. 7, the heating head 3 is not used, the bottom of the cooker body 2 can be placed on the heating base 1, and the first positioning step 11 is clamped into the first positioning recess 21. After the power wire is plugged into the first power interface 1a and electrified, the first electric heating device 4 can heat food in the body 2b, and the mouth of the cooking chamber Q is covered with a conventional lid, so that the steamer mode is realized.

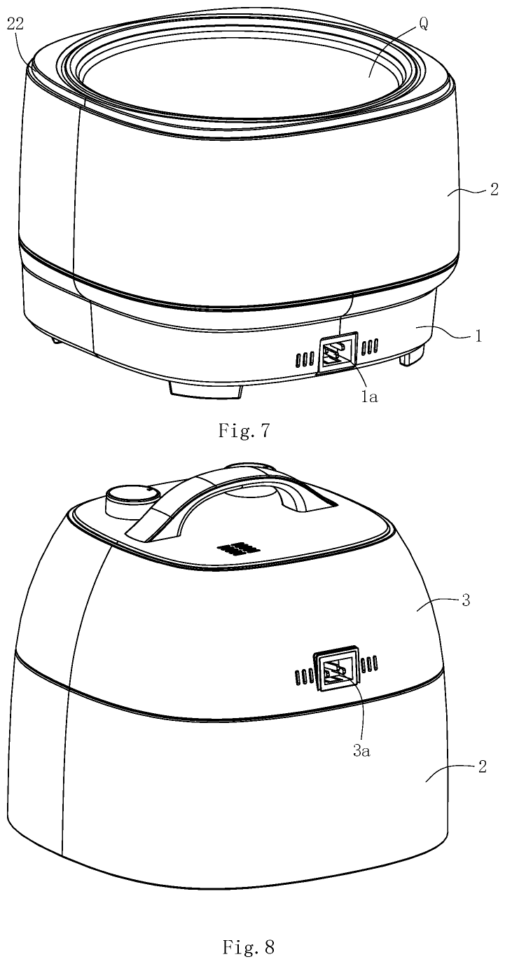

Air fryer mode: as shown in FIG. 8, the heating base 1 is not used, the heating head 3 is covered on the top of the cooker body 2, the second positioning step 22 is clapped into the second positioning recess 32, and the seal ring 31 seals the mouth of the cooker body 2. After the power wires is plugged into the second power interface 3a and electrified, the second electric heating device 5 can heat food in the cooking chamber Q, and the heating is air heating, so that the air fryer mode is realized.

Mode of using the heating base 1 alone: if the first electric heating device 4 is an induction cooker type heating structure, the induction cooker mode is realized in coordination with a conventional pot. If the first electric heating device 4 is an electric heating tube type heating structure, it is a conventional electric cooker. If the first electric heating device 4 is a microcrystalline heating structure, it can be used as a tea maker, and a teapot is directly placed on the heating base 1 for heating.

It should be noted that in the description and claims of the present invention, the terms used to indicate direction, such as “front, back”, “up, down”, “left, right”, “side, top, bottom”, etc. are used to describe structures and elements of the present invention for better explanation. And these terms used here are based on an orientation in the accompanying drawings. Since the embodiments disclosed by the present invention can be set in different directions, these terms indicating directions are only used as explanations and should not be used as restrictions.

1. A multiduty cooking appliance comprising a heating base, a cooker body having a top and a bottom, a heating head, a first electric heating device disposed inside the heating base, and a second electric heating device disposed inside the heating head;
wherein,
the cooker body encloses a cooking chamber and has an opening on the top;
the first electric heating device and the second electric heating device are independent of each other;
when the bottom of the cooker body is placed on the heating base, the cooking chamber is disposed on top of the first electric heating device and the first electric heating device is capable of heating the cooking chamber;
when the heating head is placed on the top of the cooker body and covers the cooking chamber, the second electric heating device inside the heating head is capable of heating the cooking chamber.

2. The cooking appliance of claim 1, wherein the heating base has a first power interface for receiving a power wire to supply power to the first electric heating device, and the heating head has a second power interface for receiving a power wire to supply power to the second electric heating device.

3. The cooking appliance of claim 1, wherein the first electric heating device is an electric heating tube type heating structure, an induction cooker type heating structure or a microcrystalline heating structure, and a temperature adjustment control panel or a button is arranged at a front side of the heating base.

4. The cooking appliance of claim 1, wherein the second electric heating device is an air fryer type heating mechanism, and comprises a motor having a output shaft, a cooling fan, a heat circulating fan and a heating tube;
both the cooling fan and the heat circulating fan are connected to the output shaft of the motor, a control knob or a control panel is arranged on the heating head.

5. The cooking appliance of claim 1, wherein positioning mechanisms are respectively arranged between a top of the heating base and the bottom of the cooker body and between a bottom of the heating head and the top of the cooker body.

6. The cooking appliance of claim 5, wherein an annular first positioning step is formed on the top of the heating base, a first positioning recess for receiving the positioning step is formed on the bottom of the cooker body, when the cooker body is placed on the heating base the first positioning step latches inside the first positioning recess.

7. The cooking appliance of claim 6, wherein the first electric heating device having a heating surface is positioned inside the heating base and is capable of floating up and down, and the first electric heating device is supported by a springs to extend the heating surface of the first electric heating device beyond a top surface of the first positioning step.

8. The cooking appliance of claim 5, wherein an annular second positioning flange is formed on the top of the cooker body, a second positioning recess receiving the second positioning flange is formed on the bottom of the heating head, when the heating head is placed on the cooker body the second positioning flange latches inside the second positioning recess.

9. The cooking appliance of claim 1, wherein a seal ring is arranged on the bottom surface of the heating head, so as to form a seal between the heating head and the cooker body when the heating head is placed on the top of the cooker body.

10. The cooking appliance of claim 1, wherein the cooker body comprises a housing and a cooking container with an inner chamber;
the housing has a shell with an inner wall and a liner with a peripheral wall which flares outwardly towards the bottom of the liner, the liner has a circular through hole running through the liner, and the cooking container is removably placed inside the through hole;
a heat insulating space is defined between the inner wall of the shell and the peripheral wall of the liner;
the cooking container has an outwardly flaring edge on the top of the cooking container which rests on the top of the liner, and the inner chamber of the cooking container is defined as the cooking chamber.

11. The cooking appliance of claim 1, wherein the heating base, the cooker body, and the heating head are mutually detachable.
